(19) United States
(12) Patent Application Publication
(10) Pub. No.: US 2010/0323635 A1
(43) Pub. Date: Dec. 23, 2010

(54) Apparatus and methods for minimizing phase interaction between multiple tuner solutions

(76) Inventors: Terry Steeper, Lincoln (GB); Damian Gruszka, Lincoln (GB); Andrew Johnson, Lincoln (GB); Nicholas Cowley, Wroughton (GB)

Correspondence Address: INTEL CORPORATION;c/o CPA Global, P.O. BOX 52050, MINNEAPOLIS, MN, 55402, US

(21) Appl. No.: 12/456,865

(22) Filed: Jun. 23, 2009

(51) Int. Cl. H04B 1/18; H04B 1/40; H04N 5/50

(52) U.S. Cl. 455/77; 455/188.1; 348/731; 348/E05.097; 455/296

(57) ABSTRACT

Embodiments of systems and methods for implementing multi-channel tuners are generally described herein. Other embodiments may be described and claimed.

### TECHNICAL FIELD

The present disclosure relates generally to the field of wireless communications and more particularly to methods and related systems for mitigating phase interaction in multi-tuner platforms.

### BACKGROUND

Electronics devices for consumers and businesses include increasingly more diverse functionalities. Among the functions being provided in various electronic systems such as computer systems and set top boxes is the reception of television signals or similar multimedia streams over one or more channels. A mobile computing platform, such as a laptop computer, mobile internet device, station and client may include a video receiver capable of receiving one or more multimedia signals in the same platform. This type of implementation in a platform may vary greatly depending on the specific transmission specification, which may be dependent on the geographic region or other factors.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 (Prior Art) is a graph illustrating effects of multi-channel pulling;

FIG. 2 is a block diagram of an electronic system in accordance with some embodiments of the invention;

FIG. 3 is a block diagram of the electronic system in accordance with some embodiments of the invention;

FIG. 4 is a block diagram of the electronic system accordance with some embodiments of the invention;

FIG. 5 is a graph illustrating application of phase interaction mitigation in accordance with some embodiments of the invention; and

FIG. 6 is a flowchart that describes an embodiment of a method for mitigating phase interaction between multiple tuners.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details for mitigating interaction, such as phase interaction in multi-tuner platforms are set forth to provide a thorough understanding of the invention. However, it will be understood by those skilled in the art that the present invention may be practiced without these specific details. In other instances, well-known methods, procedures, components and circuits have not been described in detail so as not to obscure the present invention.

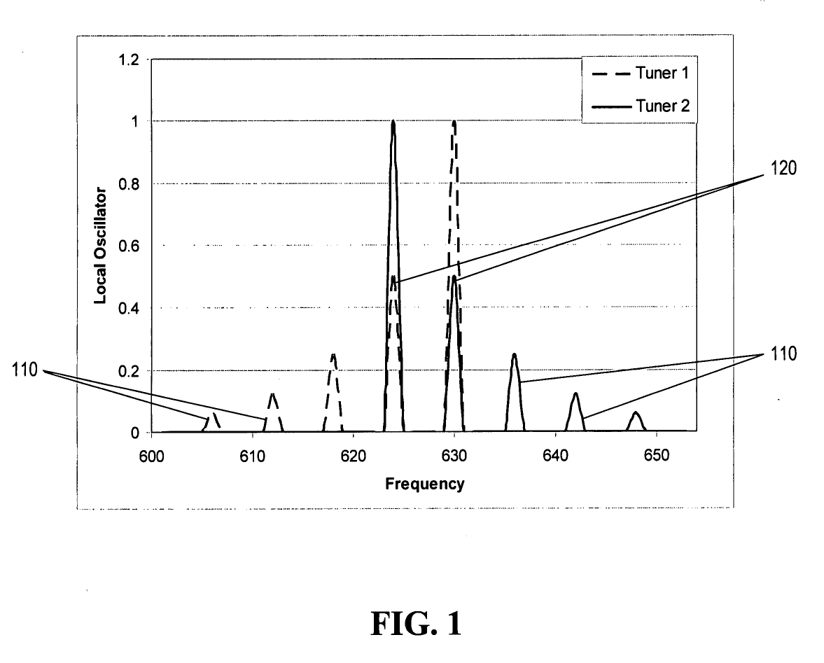

It would be an advance in the art to provide an apparatus and methods for implementing a plurality of tuners, wherein the tuners can be independently tuned to any and all channels from a commonly received spectrum and wherein all or part of the tuning components are disposed on a common substrate in the same electronic platform while avoiding intra-system interaction that can negatively affect performance. Performance of electronic devices with tuners capable of receiving two or more channels from a common spectrum can degrade when the channels are tuned close to or substantially equal to the same harmonically related frequencies, resulting in impairment of the service. Typically, it is found that in such circumstances that oscillators associated with each channel or tuner can injection lock or “pull” each other when placed in close physical proximity to one another, generating multiple sidebands 110 and interference 120 in desired channels as shown in FIG. 1 (Prior Art), degrading channel quality.

Electronic systems requiring more than one tuner in the same platform or system are typically configured so that each tuner is independently isolated through application of electromagnetic coupling isolation. Application of the electromagnetic coupling isolation requires additional space and expense which is a burden, particularly in mobile devices designed with small form factors for low cost applications. It would be advantageous to employ a system and methods to avoid phase interaction between the tuners or instances where interaction may occur as opposed to reducing the effects of injection lock or “pulling.” Mitigation of phase interaction between the tuners would be especially important in instances where all or part of the components of the tuners are located on a monolithic integrated circuit or disposed on a common substrate.

Some embodiments of the invention may be used in conjunction with various devices and systems, for example, a Personal Computer (PC), a set-top box, a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, or the like. Embodiments of the invention may be used in various other devices, systems and/or networks.

The terms “interference” or “noise” as used herein include, for example, random or non-random disturbances, patterned or non-patterned disturbances, unwanted signal characteristics, Inter Symbol Interference (ISI), electric noise, electric interference, white noise, non-white noise, signal distortions, shot noise, thermal noise, flicker noise, “pink” noise, burst noise, avalanche noise, noise or interference produced by components internal to a device attempting to receive a signal, noise or interference produced by co-existing components of a device attempting to receive a signal, noise or interference produced by components or units external to a device attempting to receive a signal, random noise, pseudo-random noise, non-random noise, patterned or non-patterned interference, or the like.

The term “mitigation” (e.g., of interference or noise) as used herein includes, for example, reduction, decrease, lessening, elimination, removal and/or avoidance.

The terms “television signal(s)” or “digital television signals” as used herein include, for example, signals carrying television information, signals carrying audio/video information, Digital Television (DTV) signals, digital broadcast signals, Digital Terrestrial Television (DTTV) signals, signals in accordance with one or more Advanced Television Systems Committee (ATSC) standards, Vestigial SideBand (VSB) digital television signals (e.g., 8-VSB signals), Coded ODFM (COFDM) television signals, Digital Video Broadcasting-Terrestrial (DVB-T) signals, DVB-T2 signals, Integrated Services Digital Broadcasting (ISDB) signals, digital television signals carrying MPEG-2 audio/video, digital television signals carrying MPEG-4 audio/video or H.264 audio/video or MPEG-4 part 10 audio/video or MPEG-4 Advanced Video Coding (AVC) audio/video, Digital Multimedia Broadcasting (DMB) signals, DMB-Handheld (DMB-H) signals, High Definition Television (HDTV) signals, progressive scan digital television signals (e.g., 720p), interlaced digital televisions signals (e.g., 1080i), television signals transferred or received through a satellite or a dish, television signals transferred or received through the atmosphere or through cables, signals that include (in whole or in part) non-television data (e.g., radio and/or data services) in addition to or instead of digital television data, or the like.

Among the television signals that may be utilized for video is the recent China digital television standard. The standard is designated number GB20600-2006 of the SAC (Standardization Administration of China), and is entitled “Framing Structure, Channel Coding and Modulation for Digital Television Terrestrial Broadcasting System”, issued Aug. 18, 2006. The standard may also be referred to as DMB-T (Digital Multimedia Broadcasting-Terrestrial) or DMB-T/H (Digital Multimedia Broadcasting Terrestrial/Handheld). This standard will generally be referred to herein as “DMB-T”.

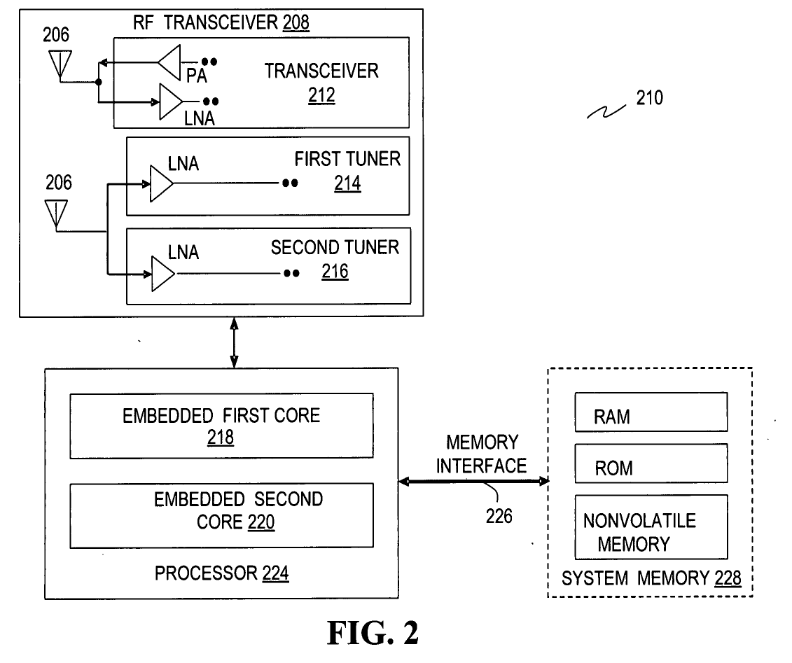

FIG. 2 illustrates an electronic system 210 that incorporates multiple radios in a common platform to allow communication with other over-the-air communication systems according to some embodiments of the invention. In another embodiment of the invention (not shown), the electronic system 210 is a wired communications system that is configured to allow communication with two or more wired and/or wireless communication devices. The electronic system 210 may operate in a number of networks such as, for example, Digital Video Broadcasting-Handheld (DVB-H) that brings broadcast services to handheld receivers as adopted in the ETSI standard EN 302 304; Digital Multimedia Broadcasting (DMB); Digital Video Broadcasting-Terrestrial (DVB-T); the Integrated Services Digital Broadcasting-Terrestrial (ISDB-T) in Japan; or Wireless Fidelity (Wi-Fi) that provides the underlying technology of Wireless Local Area Network (WLAN) based on the IEEE 802.11n specifications, although the present invention is not limited to operate in only these networks. Thus, the radio subsystems co-located in electronic system 210 provide the capability of communicating in an RF/location space with other devices in a network.

The simplistic embodiment illustrates an RF transceiver 208 with one or more antenna(s) 206 that may receive host transmissions such as WWAN, WiFi, etc., that are coupled to a transceiver 212 to accommodate modulation/demodulation. The antennas 206 also receive transmission for a first tuner 214 and a second tuner 216 to receive “data bits” used to make a TV picture and sound in the Digital television (DTV) broadcasting technology from a commonly received spectrum. The commonly received spectrum may be the same spectra, for example a terrestrial television transmission or independent spectra sharing common frequencies, for example terrestrial television transmissions and cable television transmissions.

Each antenna 206 may comprise one or more directional or omnidirectional antennas, including, for example, dipole antennas, monopole antennas, patch antennas, loop antennas, microstrip antennas, or other types of antennas suitable for transmission of radio frequency (RF) signals. In some embodiments, instead of two or more antennas 206, a single antenna 206 with multiple apertures may be used. In these embodiments, each aperture may be considered a separate antenna 206. In some multiple-input, multiple-output (MIMO) embodiments, the RF transceiver 208 may use two or more of antennas 206 that may be effectively separated to take advantage of spatial diversity and the different channel characteristics that may result between each of the antennas 206 and one or more host transmission source(s) transmitting a transport stream.

Appropriate to received MPEG-2 transport streams and the different technical constraints of the received data, a demodulation scheme may be selected to provide the demodulated signals to a processor 224. By way of example, the receiver may include OFDM blocks with pilot signals and the digital demodulation schemes may employ QPSK, DQPSK, 16QAM and 64QAM, among other schemes. The analog transceiver 212, first tuner 214, and the second tuner 216 may be embedded with a processor 224 as a mixed-mode integrated circuit where baseband and applications processing functions may be handled by processor cores 218 and 220.

The processor 224 may transfer data through a memory interface 226 to memory storage in a system memory 228 comprising one or more of a volatile and/or nonvolatile memory for storage. For example, nonvolatile memory may include one or more of the following: read-only memory (ROM), programmable ROM (PROM), erasable PROM (EPROM), electrically EPROM (EEPROM), a disk drive or solid state drive (e.g., 228), a floppy disk, a compact disk ROM (CD-ROM), a digital versatile disk (DVD), flash memory, a solid-state drive (SSD), a magneto-optical disk, or other types of nonvolatile machine-readable media capable of storing electronic data including instructions.

The processor 224 as illustrated in this embodiment provides two core processors or central processing unit(s). The processor 224 may be any type of processor such as a general purpose processor, a network processor (which may process data communicated over a computer network), etc. (including a reduced instruction set computer (RISC) processor, an application specific integrated circuit (ASIC), or a complex instruction set computer (CISC)). In alternate embodiments, the processor 224 may have a single or quad core design. The processor 224 with a multiple core design may integrate different types of processor cores on the same integrated circuit (IC) die. Also, the processor 224 with a multiple core design may be implemented as symmetrical or asymmetrical multiprocessors.

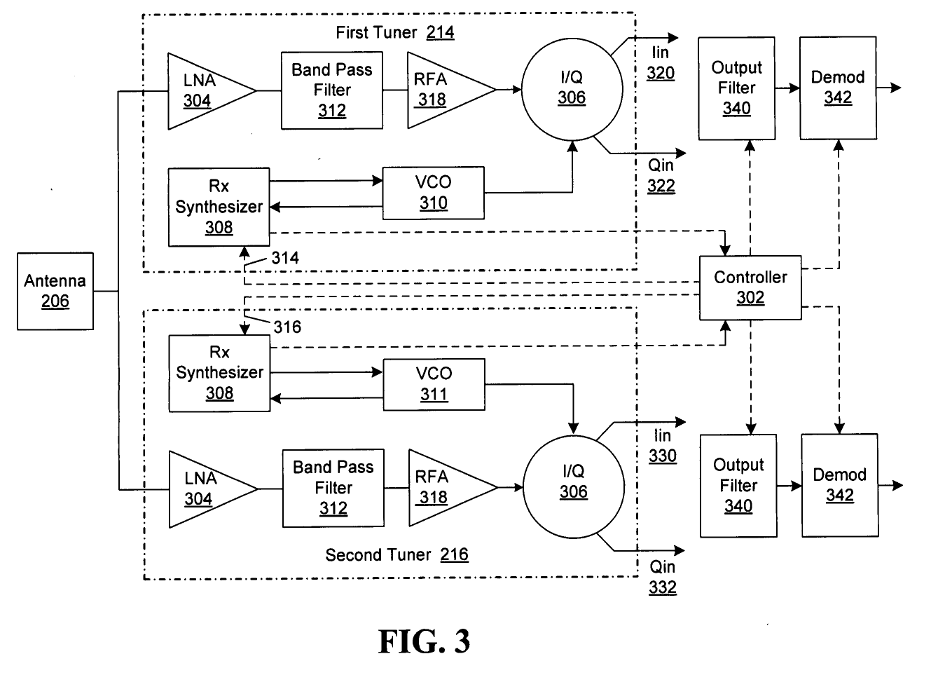

FIG. 3 is a block diagram of the electronic system 210 in accordance with some embodiments of the invention. The antenna 206 of FIG. 2 is coupled to the first tuner 214 and the second tuner 216, wherein both tuners are connected to a controller 302. Two tuners 214, 216 are illustrated in FIG. 3, however additional tuners may also be connected and positioned proximate to the first tuner 214 and/or the second tuner 216. The controller 302 may be the processor 224 of FIG. 2 or a separate controller in the form of a general purpose processor, a network processor (which may process data communicated over a computer network), etc. (including a reduced instruction set computer (RISC) processor, an application specific integrated circuit (ASIC), or a complex instruction set computer (CISC)).

In this embodiment, the first tuner 214 and the second tuner 216 each comprise a low noise amplifier (LNA) 304 that is used to amplify signals captured by the antenna 206. The amplified signals are passed to a band pass filter 312 that is used to suppress a leakage power of the transmission and other out of the receiver band interference, then passed to a radio frequency amplifier (RFA) 318 and an I/Q downconverter or mixer 306. The first tuner 214 further comprises a receive (Rx) synthesizer 308 coupled to a first voltage controlled oscillator (VCO) 310 and the second tuner 216 further comprises a receive (Rx) synthesizer 308 coupled to a second VCO 311.

Each VCO 310, 311 forms a periodic output signal wherein a frequency of the periodic output signal is set by a direct current (DC) control voltage applied by the controller 302 using a tuning input, such as a first tuning input 314 or a second tuning input 316, that is applied through the Rx synthesizer 308. The control voltage of the first tuning input 314 or a second tuning input 316 is then adjusted up or down to control the frequency of the periodic output signal of the VCOs 310, 311. A center frequency provided by the VCOs 310, 311 is the frequency of the periodic output signal formed by the VCOs 310, 311 when the control voltage is set to a nominal level. The control voltage of the VCOs 310, 311 may be generated at least in part by integrating an output of a phase detector of the Rx synthesizer 308, wherein the Rx synthesizer 308 compares a reference frequency (not shown) and an input from the VCOs 310, 311.

As described earlier, when the first VCO 310 of the first tuner 214 is placed in proximity to the second VCO of the second tuner 216, such as on a common substrate or monolithic integrated circuit, that is tuned to the same or close to the same or a harmonic frequency as the first VCO 310, any energy close to the resonant frequency that couples into the first VCO 310 at or close to the same or a harmonic frequency thereof will be amplified within the first VCO 310 and the second VCO 311, resulting in an interaction. The interaction between the first VCO 310 and the second VCO 311 may result in the spectrum illustrated in FIG. 1 (Prior Art).

To overcome this interaction between the first VCO 310 and the second VCO 311, an offset may be applied by the controller 302 using a mechanism embodied in hardware or through a an algorithm that can predict and/or detect interaction between the VCOs 310, 311 in the electronic system 210 having multiple tuners operating either at the same frequency, very close to the same frequency, or at a harmonically related frequency. The algorithm is configured to re-calculate relevant settings to deliberately offset at least one VCO 310, 311 by a sufficient amount to prevent interaction between the first VCO 310 of the first tuner 214 and the second VCO 310 of the second tuner 216.

As an example, the algorithm may detect interaction by determining or detecting a frequency that a first VCO 310 is tuned to and verifying that a second VCO 311 is not an integer multiple of the frequency of the first VCO 310. In one embodiment, the first tuner 214 is tuned to 250 megahertz (MHz) with the first VCO 310 operating at 1,000 MHz, and a total division ratio of 4 prior to the mixer 306. If the second tuner 216 were to be tuned to 1,000 MHz by operating the second VCO 311 at 2,000 MHz and selecting a total division ratio of 2 prior to the mixer 306, then the two VCOs 310, 311 would be harmonically related, wherein the second VCO 311 is at a second harmonic of the first VCO 310. In this embodiment, the controller 302, such as through an algorithm executed on the controller 302, would predict the interaction and introduce an offset, such as by adding 1 MHz to the second VCO 311 and an intermediate frequency or zero intermediate frequency (ZIF) output of the second tuner 216 would be shifted by 500 kilohertz (KHz) due to the total division ratio of 2 prior to the mixer 306. The 1 MHz offset introduced between the first VCO 310 and the second VCO 311 avoids or mitigates interaction between the first VCO 310 and the second VCO 311 while meeting necessary channel requirements for the first tuner 214 and the second tuner 216. In an alternate embodiment, the controller 302 would predict the interaction and introduce an offset, such as by adding 1 MHz to the first VCO 310.

Several factors affect how close in frequency the VCOs 310 can operate before interacting or otherwise pulling each other from their respective desired frequencies toward a common frequency, wherein the VCOs 310, 311 harmonize or ‘lock’ together. Even if independent frequencies of the VCOs 310, 311 are maintained, it is still possible to form the sidebands illustrated in FIG. 1 (Prior Art) that would appear in output signals of the first VCO 310 and the second VCO 311. The factors include positioning and implementation of the tuners and a Q factor of each VCO 310, 311 among other factors known to one skilled in the art. As the Q factor increases, the smaller the offset needs to be between an operating frequency of a first VCO 310 and a second VCO 311 to prevent harmonization and/or the formation of sidebands 110. Harmonization and/or formation of sidebands 110 or interference 120 of FIG. 1 (Prior Art) is detrimental to the quality of the intermediate frequency or zero intermediate frequency produced by the first tuner 214 and/or the second tuner 216 and would result in loss of performance due to spurious signals introduced into the mixer 306.

The I/Q downconverter or mixer 306 is provided to receive and combine a RF signal from the RFA 318 with a frequency signal from the VCO 310 to provide an in-phase Iin 320 signal and a Quadrature signal (Qin) 322 to downstream components such as an output filter 340 and a demodulator 342. The controller 302 is also configured to adjust the demodulator 342 to remove the offset to provide a first commutating frequency from the first tuner 214.

In this embodiment, the first tuner 214 comprises a first VCO 310 and the second tuner 216 comprises a second VCO 311 that may be offset from the other, however the embodiment is not so limited. As an alternative, the controller 302 may execute an algorithm for offsetting the first VCO 310 of the first tuner to accommodate a second tuner 216 that is not configured to provide an offset (not shown) to an output frequency of the first VCO 310.

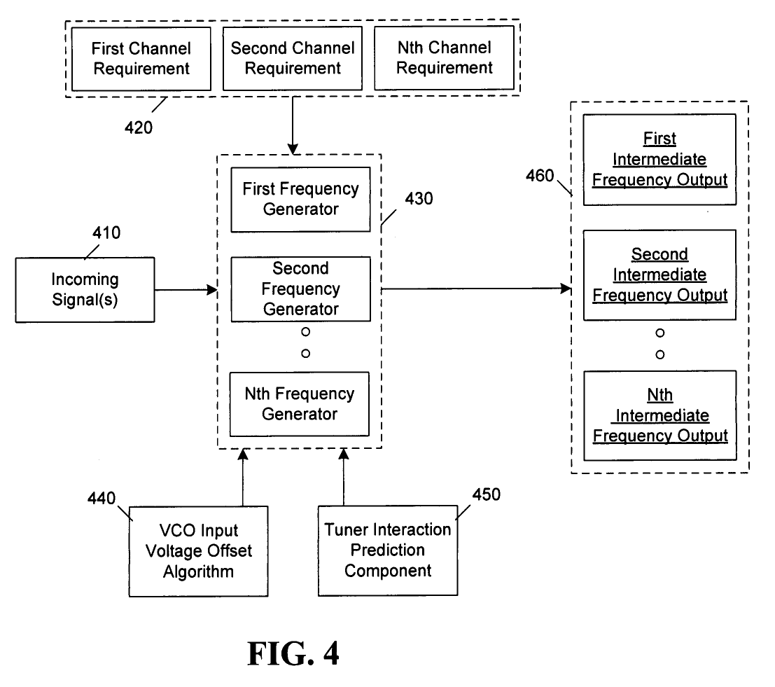

FIG. 4 is a block diagram of the electronic system 210 of FIG. 2 in accordance with some embodiments of the invention. An incoming signal 410, received by one or more antennas 206 in the form of an RF signal, is used to make a TV picture and sound using Digital television (DTV) broadcasting technology from a commonly received spectrum. The electronic system 210 is configured with multiple tuners such as the first tuner 214 and the second tuner 216 of FIG. 2 and receives one or more channel requirements 420 from one or more sources such as a user, a programmed source such as a digital video recorder (DVR), a networked source, and/or another source. A plurality of frequency generators 430 represents the plurality of tuners (e.g. first tuner 214 & second tuner 216), each tuner comprising an amplifier 304, mixer 306, Rx synthesizer 308, VCO 310, 311 band pass filter 312, and an RFA 318. One or more outputs of the plurality of frequency generators 430 are modified by a VCO input voltage offset algorithm or component 440 embodied as a logic block or software subroutine, and a tuner interaction prediction component 450 which may be embodied in hardware and/or software form. For example, the VCO input voltage offset 440 and tuner interaction prediction component 450 may be software subroutines processed on the controller 302 of FIG. 3. Outputs from the frequency generators 430 are provided in the form of intermediate frequency outputs 460 to accommodate the channel requirements 420. In another embodiment (not shown), the outputs 460 may be in the form of ZIF outputs.

In one embodiment, interaction may be mitigated between tuners 214, 216 when receiving a channel request or channel requirement 420 through determining a first frequency for a first oscillator such as the first VCO 310 or other frequency generation device of the first tuner 214 based at least in-part on the channel request. A second frequency of a second oscillator such as the second VCO 311 or other frequency generation device of the second tuner 216 is determined and it is predicted whether the first oscillator, if tuned to the first frequency, will interact with the second oscillator at the second frequency using the tuner interaction prediction component 450, wherein it may be determined whether the first frequency is equal to, substantially equal to, or harmonically related to the second frequency.

Where interaction is predicted or likely to occur, an offset is determined for the first oscillator using the VCO input voltage offset algorithm 440 and the offset is combined with the first frequency, such as by adding or subtracting the offset to the first frequency. The combined offset and first frequency is transmitted by the first oscillator and the second frequency is transmitted by the second oscillator to provide the intermediate frequency outputs 460. The first frequency with the offset is determined to avoid harmonics or sub-harmonics of the second frequency. The offset may be removed by a demodulator 342 to provide a desired first commutating frequency from the first tuner 214 with the second commutating frequency from the second tuner 216. Further, an output filter 340 in the form of an intermediate frequency filter or a zero intermediate frequency filter may be widened to allow a first frequency with an offset to pass through to the demodulator 342. The output filter 340 and the demodulator 342 may be coupled to the controller to provide for the offset. In another embodiment (not shown), ZIF outputs are provided instead of the intermediate frequency outputs 460.

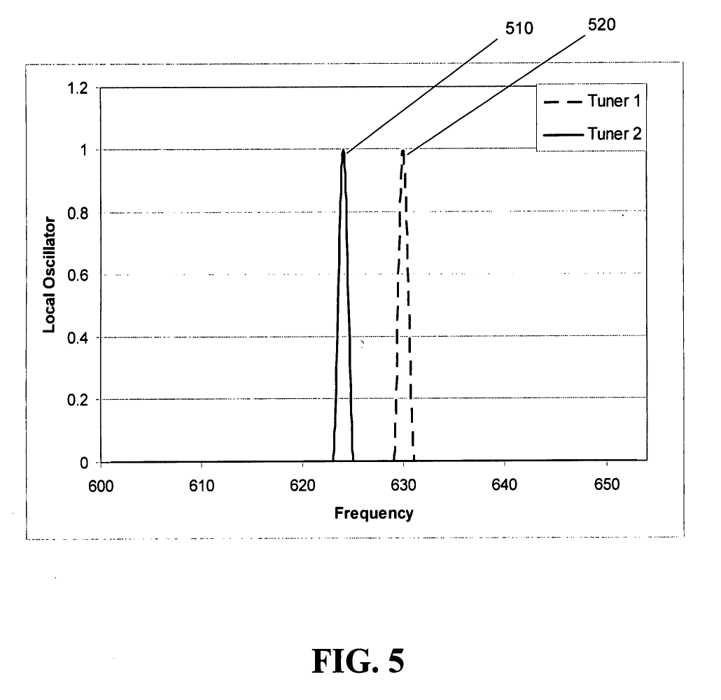

FIG. 5 is a graph illustrating application of VCO offset(s) in accordance with some embodiments of the invention. Two peaks are illustrated, representing a first resonant frequency peak 510 of a first commutating frequency and a second resonant frequency peak 520 of a second commutating frequency lacking the sidebands 110 and the interference 120 of legacy systems, previously illustrated in FIG. 1 (Prior Art).

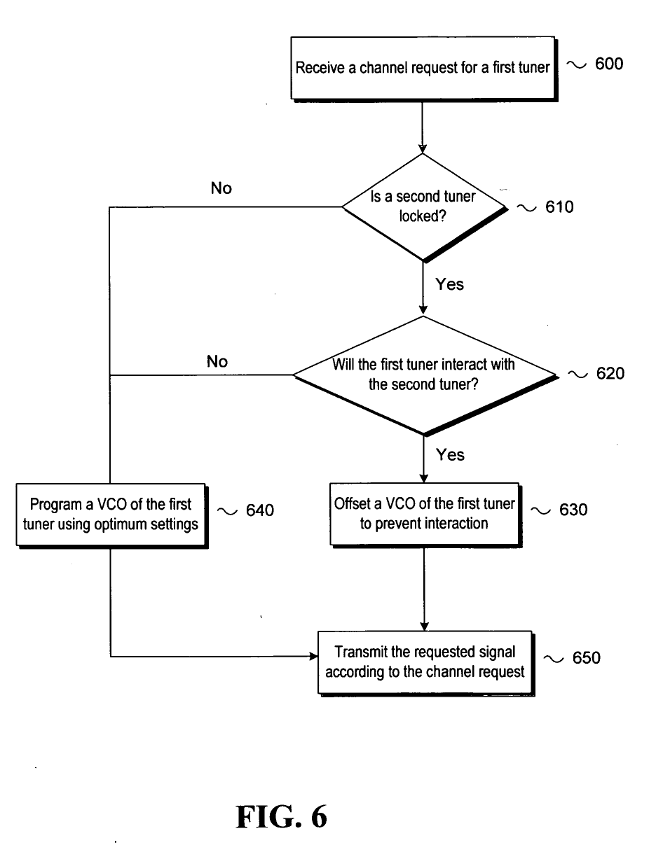

FIG. 6 is a flowchart that describes an embodiment of a method for mitigating multi-tuner interaction, or the harmonization and/or formation of sidebands 110 or interference 120 in an intermediate frequency or ZIF output signal. In element 600, a channel request is received for the first tuner 214. In element 610, it is determined whether the second VCO 311 of the second tuner 216 is tuned at a second frequency. If the second VCO 311 of the second tuner 216 is not tuned to a second frequency, the first VCO 310 of the first tuner 214 is programmed in element 640 according to the channel request of element 600 and a first commutating frequency from the first tuner 214 is transmitted according to the channel request in element 650. If the second VCO 311 of the second tuner 216 is tuned at a second frequency, it is determined in element 620 whether a first frequency of the first VCO 310 for the first tuner 214 will interact with the second frequency of the second VCO 311 of the second tuner 216. If it is predicted there will be no interaction, then the first VCO 310 of the first tuner 214 will be programmed according to element 640 using optimal settings, or settings that are optimized based at least in part upon the channel request for the first tuner 214 and a first commutating frequency from the first tuner 214 is transmitted according to the channel request in element 650.

If it is predicted there will be interaction, then the first VCO 310 of the first tuner 214 will be offset in element 630 to prevent interaction between the first VCO 310 and the second VCO 311. The offset signal from the first tuner 214 is transmitted according to the channel request in element 650. Prediction of whether there will be interaction between the first VCO 310 of the first tuner 214 and the second VCO 311 of the second tuner 216 is dependent upon implementation and design of the first tuner 214 and the second tuner 216. Interaction between the VCOs 310, 311 is discoverable upon testing of the specific implementation and design. The point upon which interference and locking occurs between the first VCO 310 and the second VCO 311 is based at least in-part upon a Q factor of each VCO 310, 311 and a relative strength of injected interference, though the embodiment is not so limited. The higher the Q factor, the closer the interfering VCO 310, 311 can be in frequency terms before interference and locking occurs. Prediction of interaction and/or locking for the specific implementation of the tuners, such as a first tuner 214 and a second tuner 216, may be determined through calculation performed using the controller 302, using a look-up table, a combination of calculation and a look-up table, or using another suitable method. In this embodiment, two tuners 214, 216 have been provided, though the embodiment is not so limited and the method may be modified to accommodate additional tuners (not shown). For example, a third tuner may be co-located proximate to the first tuner 214 and the second tuner 216.

Embodiments may be described herein with reference to data such as instructions, functions, procedures, data structures, application programs, configuration settings, etc. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by the electronic system 210, performs multi-channel tuner capability without tuner to tuner interaction. The programs in the electronic system 210 may be considered components of a software environment.

The operation discussed herein may be generally facilitated via execution of appropriate firmware or software embodied as code instructions on the host processor 224 of the electronic system 210, as applicable. Thus, embodiments of the invention may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method for mitigating interaction between tuners, comprising:
receiving a channel request for a first tuner;
determining a first frequency for a first oscillator of the first tuner based at least in-part upon the channel request;
determining a second frequency of a second oscillator of a second tuner;
predicting if the first oscillator, tuned to the first frequency, will interact with the second oscillator at the second frequency;
determining an offset to the first frequency for the first oscillator if interaction is predicted; and
transmitting the first frequency with the offset by the first oscillator and the second frequency by the second oscillator.

2. The method of claim 1, wherein the first frequency of the first oscillator is transmitted according to the channel request if the second tuner is not tuned to a second frequency.

3. The method of claim 1, wherein the first frequency of the first oscillator is transmitted according to the channel request if interaction is not predicted.

4. The method of claim 1, wherein the first frequency with the offset is not a harmonic frequency or a sub-harmonic frequency of the second frequency.

5. The method of claim 1, further including predicting if the first frequency is equal to, substantially equal to, or harmonically-related to the second frequency.

6. The method of claim 1, wherein the first oscillator and the second oscillator are located on the same substrate or monolithic integrated circuit.

7. The method of claim 1, further including removing the offset to the first frequency by a demodulator.

8. A method of receiving a shared spectrum signal and transmitting a first commutating frequency from a first tuner and a second commutating frequency from a second tuner, comprising determining if a first oscillator of the first tuner will be operating substantially equal to or at a harmonically related frequency as a second oscillator of the second tuner, adding an offset to the first oscillator, and removing the offset in a demodulator to provide the first commutating frequency.

9. The method of claim 8, wherein the first commutating frequency of the first tuner is transmitted according to the channel request without the offset if the second tuner is not tuned.

10. The method of claim 8, wherein the first commutating frequency of the first tuner is transmitted according to the channel request without the offset if interaction between the first oscillator and the second oscillator is not predicted.

11. The method of claim 8, wherein the first frequency with the offset for the first oscillator is not a harmonic frequency or a sub-harmonic frequency of the second frequency for the second oscillator.

12. The method of claim 8, further including predicting if the first frequency for the first oscillator is harmonically-related to the second frequency for the second oscillator.

13. The method of claim 8, wherein the first oscillator and the second oscillator are located on the same substrate or monolithic integrated circuit.

14. The method of claim 8, further including widening an intermediate frequency filter or a zero intermediate filter to allow the offset to pass to the demodulator.

15. A multi-tuner system for providing a plurality of commutating frequencies, comprising:
a first tuner to generate a first commutating frequency according to a channel request, the first tuner comprising a first voltage controlled oscillator (VCO);
a second tuner to generate a second commutating frequency, the second tuner comprising a second VCO; and
a controller to predict if the first VCO at a first frequency will interact with the second VCO at a second frequency, wherein the controller provides an offset to the first frequency if the first VCO will interact with the second VCO.

16. The multi-tuner system of claim 15, wherein the first tuner and the second tuner of the multi-tuner system are proximately positioned without electromagnetic coupling isolation.

17. The multi-tuner system of claim 16, wherein the multi-tuner system is a monolithic integrated circuit.

18. The multi-tuner system of claim 15, further including a first receiver (Rx) synthesizer coupled to the first VCO.

19. The multi-tuner system of claim 18, further including providing a first tuning input to the Rx synthesizer to apply an input voltage offset to the first VCO.

20. The multi-tuner system of claim 15, further including a demodulator coupled to the controller wherein the controller is configured to adjust the demodulator to remove the offset to provide the first commutating frequency.
